(19) United States
(12) Patent Application Publication
(10) Pub. No.: US 2009/0135387 A1
(43) Pub. Date: May 28, 2009

(54) Laser Irradiation

(76) Inventor: Patrick Linder, Mandach (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/571,595

(22) PCT Filed: Jun. 30, 2005
(86) PCT No.: PCT/CH2005/000366

§ 371 Date: Aug. 11, 2008

(30) Foreign Application Priority Data
Jul. 3, 2004 (EP) 04015697-8

(51) Int. Cl. G03B 27/42; G03B 27/32

(52) U.S. Cl. 355/53; 355/77

(57) ABSTRACT

The invention relates to an optical arrangement for transmitting a structure from a mask (4), and for the corresponding irradiation of a substrate (7). Said optical arrangement comprises a region for expanding a light beam (13) upstream of the mask (4), and a region for converging the light (15) downstream of the mask (4). The light beam can be expanded upstream of the mask both by means of a lens arrangement (2, 3) and by means of an optical mirror element (31, 32, 33, 51, 52, 53), and the beam of rays can be converged or combined analogously by means of a lens arrangement (5, 6) or an optical mirror element (37, 38, 39, 59). A laser source can be used as a light source (1), and a slide or a shutter can be used as the mask.

The present invention relates to an optical arrangement according to the preamble of Claim 1, a method for exposure of base circuit boards, such as semiconductor substrates or wafers, such as semiconductor wafers for the manufacture of semiconductors or microcircuits (also known as integrated circuits or ICs), a use of the optical arrangement, and an application of the method.

Circuits, in particular those such as semiconductor circuits or so-called chips or integrated circuits, are being dimensioned increasingly smaller and, what is more, the circuit structures arranged on them are becoming ever more complicated and finer. Accordingly, it is important for the masks used to make the structures to become more precise and also for the transmission to be increasingly more precise, especially that by means of UV light. The resolution of such structures can be as small as 90 nm.

In this context, U.S. Pat. No. 5,495,280 proposes an optical arrangement by means of which a matrix pattern is transmitted by reflection of a light beam from the pattern onto a substrate, in order to produce a corresponding structure on this semiconductor substrate.

Moreover, US patent application 2002/0105629 describes an optical arrangement by which a structure is defined on a substrate by means of imaging.

The light emission can be either pulsed or continuous.

In US 2004/0114132, again, an optical arrangement is described for the checking or testing of a matrix created on a substrate by lithographic techniques.

Finally, in the Japanese intellectual property documents JP 60-083019 and JP 01-198759, optical arrangements are again presented, in which a pattern is transferred by a mask using light onto a substrate in order to lithographically produce a corresponding structure.

With the various optical arrangements described in the prior art, it is virtually impossible to produce the fine structures demanded today, especially for semiconductor circuits.

The goal of the present invention is to propose steps making even finer structures possible, especially in so-called chip or IC production.

According to the invention, the stated goal is achieved by an optical arrangement according to the wording of Claim 1. It is proposed to use an optical arrangement for the transferring of a structure by a mask and the corresponding exposure of base circuit boards for the manufacture of microcircuits, like so-called ICs or chips, which enables widening of a light beam in front of the mask and focusing of the light having passed through the mask prior to the exposure of the base circuit board.

By light is meant both visible light, and the adjoining invisible wave region, such as UV light, infrared light, the visible spectrum, etc., etc. Preferably, the light is as coherent as possible, such as a laser beam.

According to one variant embodiment, it is proposed to place a collimator lens in front of the mask, in order to collimate the widened light in parallel and send it through the mask, and to arrange another collimator lens in front of the base circuit board in order to once again collimate the convergent or focused light after the mask so as to expose the base circuit board with a parallel bundle of rays.

In the proposals previously described in the prior art, either the light is focused prior to the mask or afterwards in order to create the corresponding structure on the substrate. It has been found that due to the focusing the light does not impinge perpendicularly on the mask structure or on the subsequently exposed substrate, so that color falsifications or indistinct edge distortions may occur because of the index of refraction. Thanks to the parallel sending of the light through the mask according to the invention, and also possibly the parallel exposing of the base circuit boards, for example, an index of refraction of 0 is obtained, so that there are no color falsifications or extremely sharp edge contours. It has also been found to be advantageous to transfer a mask by transmission of light, instead of by reflection.

In particular, it is proposed to first widen the focused, mostly coherent and parallel or slightly divergent light emitted from a laser source by means of a divergent lens. The created divergent light is then collimated prior to the mask into parallel rays of light by means of a collimator lens and the thus created parallel light rays pass through the mask. After the mask, a focusing lens is used, such as a lens which can be fabricated from frequency doubling material. The now convergent light is again collimated by a collimator lens into a parallel bundle of rays, and finally the parallel laser rays impinge on the base circuit board and transfer the miniaturized mask structure.

According to another variant embodiment, instead of using the above described lens it is proposed to use a mirror arrangement, by which the original light beam is widened, sent through the mask, and then again focused by means of another mirror arrangement into a beam of rays with a smaller diameter, which is ultimately directed onto a base circuit board.

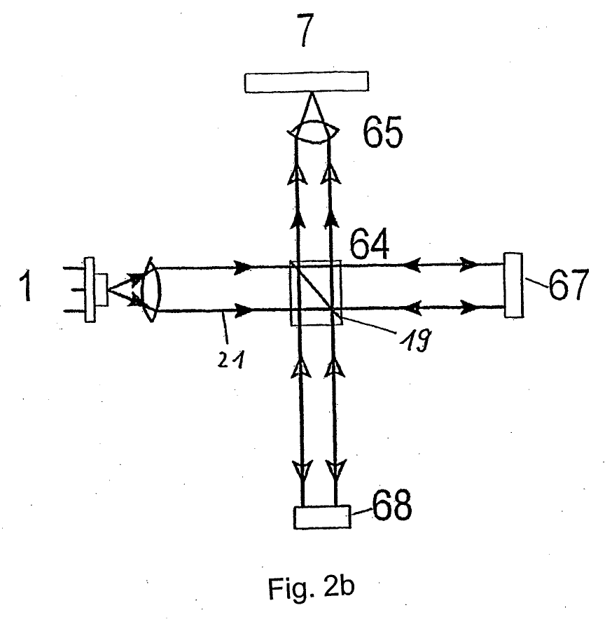

According to another variant embodiment, it is proposed to use a coherent laser beam with two waves coherently superimposed in time. The original laser beam is initially divided by a semitransparent mirror (beam splitter), for example, exactly 50% to 50%. Using a mirror system, one of the partial laser beams is delayed by a desired fraction and then the two partial laser beams are again merged, so as to be used thereafter as a rastered fractional beam. Then, as described above, the laser is at first widened, sent through the mask, then merged once again and guided onto the mask structure. A similar construction is evident from Japanese intellectual property document JP 1-198759. This serves to rotate the phase of the coherent light, but in practice this would lead to a blanking. Compare the literature, Franzis Taschenbuch [paperback book] No. 232, Stefan von Fehren, Franzis Verlag Munich, ISBN 3-7723-2321-9, coherency test with an interferometer, page 111 and page 112: “maximum coherent light with the same wavelength and rotated phase leads to the extinguishing of same”. In the claim of document JP 1-198759, one is required to achieve the most uniform possible distribution of light. In the method of the present invention, the goal is a so-called interference pattern, coming for example from a 300 nmΦ coherent light source to form several light spots with, for example, 30 nm q) diameter. Regarding temporal coherence or superimposing of two coherent partial laser beams, we refer to two publications of the Physics Institute of the University of Stuttgart, Hauptseminar SS 2000, namely, 1) Atomlithographie, Mark Rossi, section 2.2.4, Intensity gradients of photomasks, FIGS. 24 and 25, and 2) Chapter 8 of the lecture series Experimental Physics II by M. Dressel. Likewise, JP 01198759 describes, as has been described above, the creating and the superimposing of two phase-displaced waves in conjunction with a lithography process, yet having the mentioned drawbacks of the prior art.

The optical arrangement defined by the invention is especially suitable for the production of microcircuits, such as integrated circuits or so-called ICs, as well as microchips. Accordingly, the invention proposes a method according to the wording of Claim 8 for the exposing of integrated circuits to light for the production of integrated circuits or so-called chips or wafers.

Other preferred variant embodiments of the optical arrangement, as well as the method, are characterized in the dependent claims.

The invention will now be explained in greater detail with reference to the attached drawings:

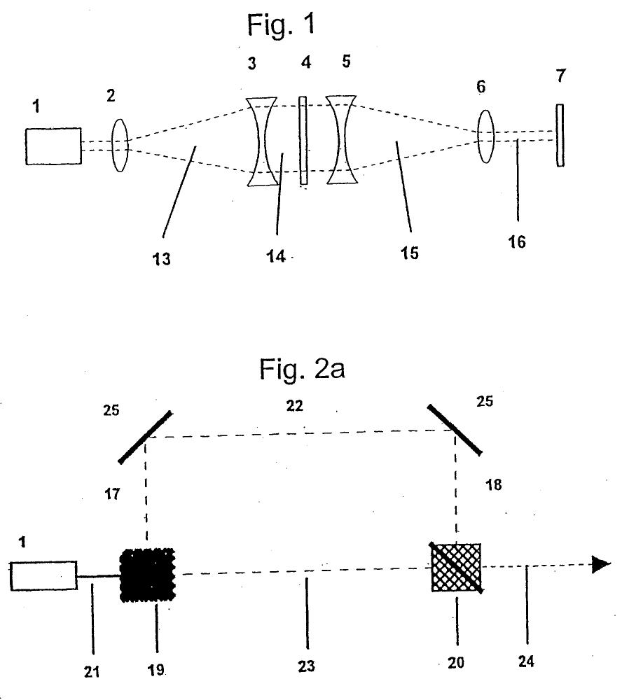

FIG. 1 shows, schematically in longitudinal section, an optical arrangement according to the invention for the laser exposure of base circuit boards or wafers;

FIG. 2a shows, schematically in longitudinal section, an arrangement for creating a fractional beam by using a coherent laser, suitable for use in an optical arrangement, represented in FIG. 1;

FIG. 2b shows, schematically in longitudinal section, another variant for creating a phase shift or a fractional beam by using a coherent laser;

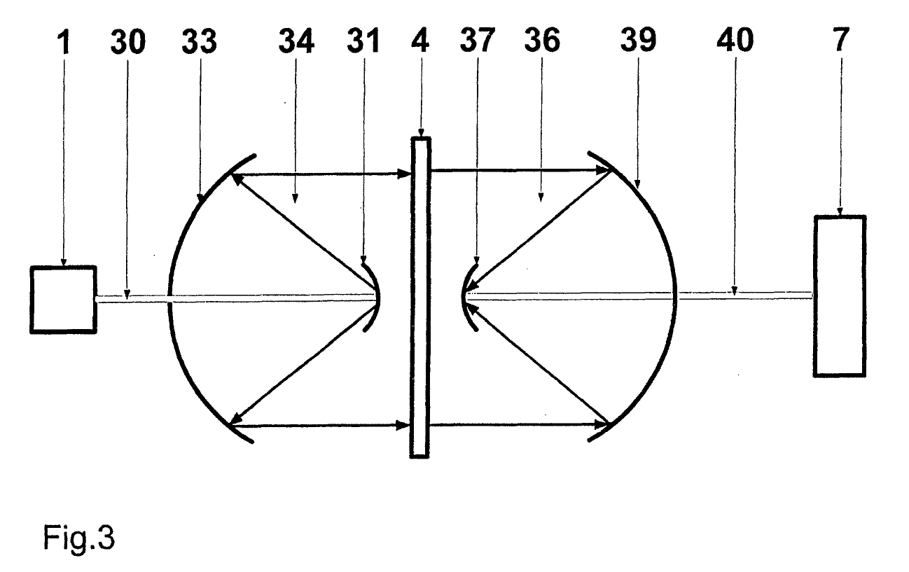

FIGS. 3 to 6 show, schematically in longitudinal section, additional variant embodiments of an optical arrangement according to the invention for the exposure of a base circuit board or a wafer; and

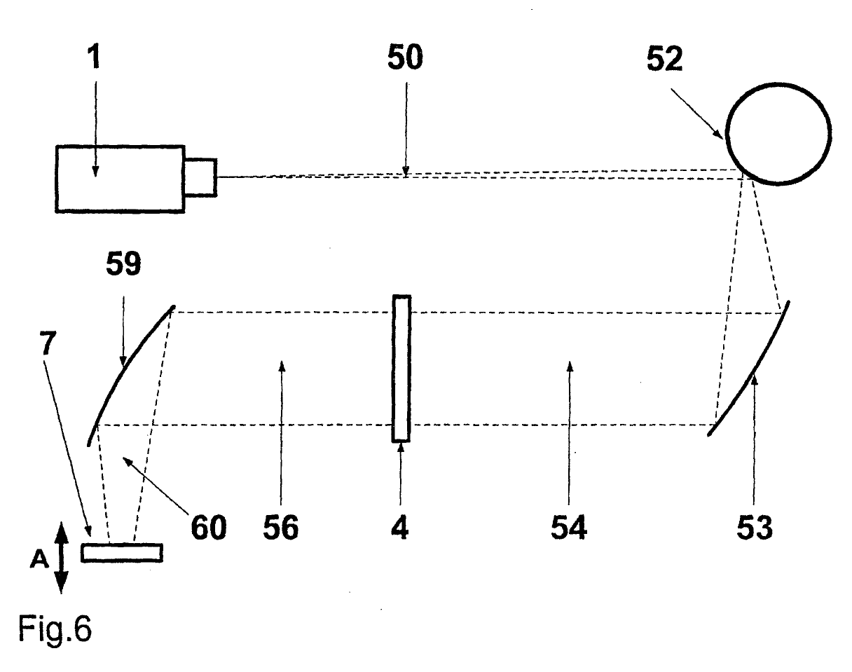

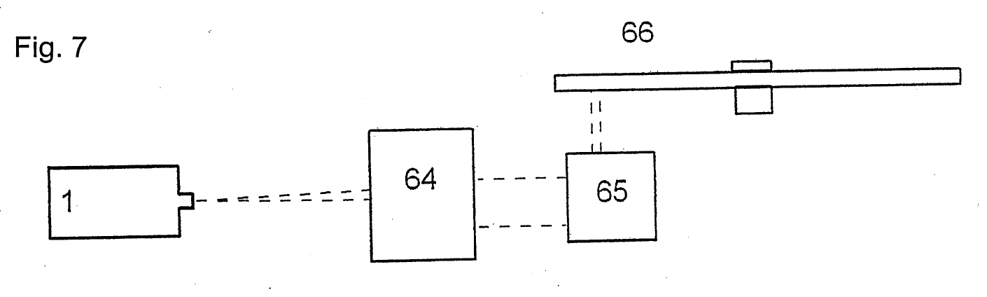

FIG. 7 shows an optical arrangement according to the invention making use of an arrangement to create a fractional beam or a phase shift, as depicted in FIGS. 2a and 2b.

FIG. 1 shows in longitudinal section an optical arrangement according to the invention for the laser exposure of base circuit boards or so-called wafers.

From a laser source 1, a parallel beam of laser rays is emitted. It is advantageous for the laser beam to have the smallest possible diameter with high coherence, that is, only one wavelength if possible. A long-wave laser can also be used in itself, but a short-wave laser beam with the smallest possible scattering is advantageous. A pulsed laser can also be used, but the pulse frequency must be smaller than or equal to the coherence length of the laser beam.

This parallel beam of rays passes through a divergent lens or divergent optics 2, thereby producing a divergent bundle of rays. By means of the collimator lens 3, the divergent bundle of rays 13 is collimated, so that once again parallel rays of light 14 are created, but they have a much larger diameter than the original laser created by the source 1. This parallel bundle of rays 14 passes through a mask 4, which can be a diaphragm or a shutter, for example. The mask contains the structure being transferred at greater magnification. After passing through the mask 4, the widened bundle of rays 14 is deflected by the focusing lens 5 into a convergent bundle of rays 15.

Once again, by means of another collimator lens 6, the convergent bundle of rays 15 is collimated into a parallel beam of laser rays 16. The precision laser beam 16 thus created ultimately impinges on the base circuit material 7 being exposed, on which the semiconductor structure is to be created.

The great benefit of the proposed optical arrangement of the invention is that a complicated structure which is to be created on a semiconductor material can be created on a relatively large mask, and then by focusing of the rays the structure can be reduced to the desired dimension. One can use a laser beam for this, being at first widened and then focused after passing through the mask, with the diameter of the final laser roughly corresponding to that of the original laser beam, or it can even be half the size or less, if frequency doubling material, for example, is used in the focusing lens 6.

Another variant is to use a coherent laser.

FIG. 2a shows schematically in longitudinal section an arrangement for the creation of a fractional beam making use of a coherent laser, suitable for use in an optical arrangement as shown in FIG. 1.

The original laser is divided by a semitransparent mirror (beam splitter), such as precisely 50%-50%, then delayed by the desired fraction of the wavelength using a mirror system, merged once more, and then used as a rastered fractional beam and taken to the divergent optics 2 according to FIG. 1. This is accomplished by dividing the original laser beam 21 with a beam splitter 19. The one laser beam 22 is delayed by a mirror optics. Path 17 and path 18 represent the delay. The slightly phase-shifted laser beams 22 and 23 of the original laser beam 21 are merged once again into a laser beam 24 by means of a mirror optics 20. By merging the two laser beams 22 and 23, only a fraction of the light quantum wave actively exposes the target. Due to the phase delay when merged, a portion of the laser beam is eliminated and only fractions of the laser light wave are propagated, such as the wave peak and valley, which are used for the rest of the optical arrangement according to FIG. 1. It has been shown that this can achieve a very high contour definition, which is attributable to the fraction of the original wavelength.

In this way, it is possible to produce very fine structures on the order of, for example, 0.018 μm, i.e., smaller or finer by a factor of 10 than the usual structures which can be produced today on wafers or chips.

FIG. 2b shows another variant of an arrangement for creating a phase shift or a fractional beam when using a coherent laser. From a coherent laser source 1, similar to FIG. 2a, the original laser beam 21 is at first taken to a beam splitter 19, where one portion is let through unreflected to the mirror 67 and the other portion is reflected and deflected to the mirror 68. Reflection occurs on both mirrors, and the laser light travels back to the beam splitter 19, which now functions in precisely the opposite way. The fractional beam or beam portion from the mirror 68 is let through unhindered to the rest of the optical arrangement, such as a focusing electromechanical system 65, and to the substrate 7, while the fractional beam or the beam portion from the mirror 67 is reflected and deflected to the rest of the optical arrangement. The two merged beam portions can then be used as a rastered fractional beam and taken, for example, to a divergent optics 2, as described in FIG. 1. But it is also possible to lead the rastered fractional beam directly through a mask and transfer the structure of the mask onto the substrate 7 by a focusing mechanism.

The arrangement shown in FIG. 2b is similar to a coherence measuring device, as described in the already cited Franzis paperback edition No. 232, ISBN 3-7723-2321-9 on page 111.

FIGS. 3 to 6 show schematically other optical arrangements according to the invention for exposure of a base circuit board or a so-called wafer to light, in longitudinal section.

According to FIG. 3, a parallel bundle of light rays 30, such as a beam of laser rays, is emitted from a light source 1, which beam impinges on a concave mirror 31, such as a so-called parabolic mirror, and is widened by deflection. The bundle of rays, divergently deflected in this way, is in turn reflected by an additional concave mirror, such as a parabolic mirror 33, thereby creating a widened parallel beam of rays 34.

Similar to the beam of rays in FIG. 1, this widened beam of rays 34 is sent through a mask 4 and after this the widened beam of rays 36, containing the “masking”, impinges on another concave hollow mirror, such as a parabolic mirror 39, so that it is again focused by reflection and further mirroring at the parabolic mirror 37 into a beam of rays 40 with a smaller diameter. Finally, the light or laser beam 40 thus created impinges on the base circuit material 7 being exposed, where a semiconductor structure, for example, is to be created.

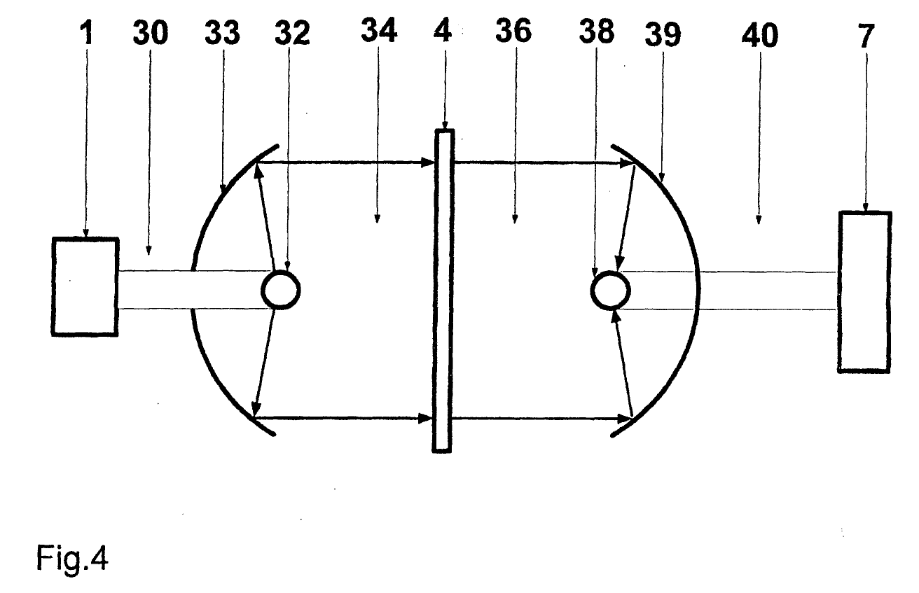

FIG. 4 shows an arrangement analogous to FIG. 3, where only the first mirror 31 according to FIG. 3 is replaced by a spherical mirror 32, which can have a surface metallized by means of a suitable metal, for example. The dimensions of the sphere 32, like those of the mirrors described previously with reference to FIG. 3 and the following figures, of course, must be designed such that the deflections of the light beams depicted in FIG. 3 to 6 are preserved.

In the arrangement according to FIG. 4, the last mirror, designated 37 in FIG. 3, is also replaced by a sphere 38, which once again has a mirror surface metallized by means of a suitable metal.

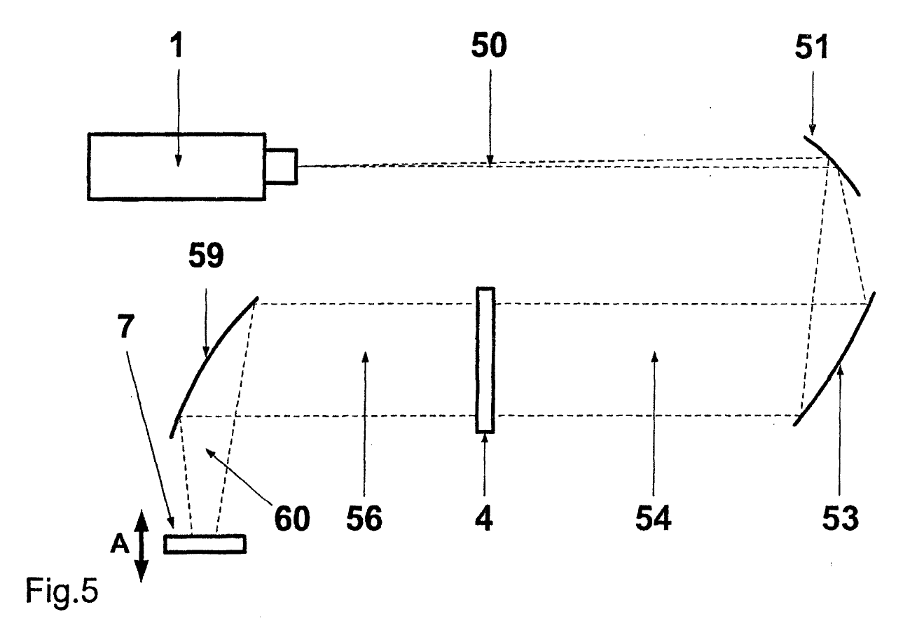

In the arrangements according to FIGS. 5 and 6, a different mirror arrangement is depicted, wherein the light beam 50 emitted by the light source 1 is not entirely parallel, but instead the originally emitted light beam is slightly divergent. The angle of divergence can be adjusted or influenced by means of a divergent optics in the light source. Said slightly divergent light beam 50 impinges on a first mirror 51, by which the bundle of rays 50 is widened and transmitted to a further mirror 53, which is configured such as to produce a parallel widened bundle of light rays 54. This is again sent through the mask 4 and the parallel light beam 56 containing the mask structure impinges on another mirror 59, by which a convergent light beam 60 is produced. Said convergent light beam 60 impinges directly on the substrate being exposed, such as a wafer 7, without focusing the convergent light beam into a parallel light bundle or beam, as in regard to the previously described arrangements.

FIG. 6 shows a similar arrangement to FIG. 5, with the difference that the first mirror 51 is again replaced by a sphere 52. The other elements, as well as the mode of operation, are analogous to what is described in regard to FIG. 5.

When necessary, or in order to improve the optical properties, a combination of lenses, mirrors, hollow mirrors, spheres and/or the like is also possible.

As already mentioned above, a significant difference from the arrangements shown in FIGS. 1 to 4 consists in that no parallel bundle of rays is produced before the light beam impinges on the substrate. The advantage of this arrangement is that the size of the structure to be created on the substrate can be varied by moving the substrate or the wafer 7 in the directions of the arrow A. If necessary, the substrate can also be arranged at a slant to the beam axis, for example if it is necessary to equalize a phase shift within the light beam.

Finally, FIG. 7 shows schematically in longitudinal section the possibility of placement of an arrangement for the creation of a fractional beam, as depicted in the two FIGS. 2a and 2b. Here, the laser beam from a coherent laser source 1 is taken through an arrangement 64, in which it is split into two fractional beams, as described in regard to the two FIGS. 2a and 2b. The fractional beam thus created, for example a rastered beam, can either be sent to an optical arrangement as described in regard to FIG. 1 or FIG. 3 to 6, or to a standard CD-DVD focusing electromechanical system 65, by means of which a pattern or a data structure can be created on a CD or DVD 66.

The described arrangements of the invention, as well as the method defined by the invention, are of course not limited to any one method of production. Of course, the arrangements as well as the method are suitable for any given optical method wherein a structure is transferred from a mask to a substrate. In other words, the present invention is in no way limited to the production of semiconductors, such as chips, but rather can be used wherever a very fine structure is to be transferred optically to a substrate by means of exposure to light. In other words, the described method of production of circuit boards, where photosensitive coatings like so-called photosensitive resists are exposed to light for the production of miniature circuits, is only a typical exemplary application and the present invention is in no way limited to this application.

The described method of the invention can also be used to write a data medium, such as a CD ROM or DVD, with considerably more data, without having to use a blue or even a UV-color laser for this. Thus, with the help of the coherence pattern, as created by means of an arrangement depicted in FIGS. 2a and 2b, much smaller pixels can be written. Thus, for example, instead of pixels of 900 nm, the same laser can now be used to write pixels of 225 nm, for example. This, in turn, means a larger volume of data than if only a so-called blue laser were being used (around 473 nm).

1. Optical arrangement for the transfer of a structure from a mask and corresponding exposure of a substrate to light, characterized by an optical arrangement having one region for widening a light beam in front of the mask (4) and one region, coming after the mask, for focusing the light, wherein the region for widening in front of the mask is such that the light can be sent in largely parallel fashion through the mask.

2. Arrangement according to claim 1, characterized in that a collimator lens (3) is arranged to collimate the widened or divergent light in parallel and send it through the mask (4), and a further collimator lens (6) is arranged in front of the substrate (7) to once again collimate the focused light or convergent light after the mask to expose the substrate to a parallel bundle of rays.

3. Arrangement according to claim 1, characterized in that a mirror optics (31, 33, 32, 51, 53, 52) is provided to widen and parallel-collimate the light beam, and an additional mirror optics (37, 39, 38, 59) is provided to again focus the widened beam having passed through the mask (4) into a parallel beam with a smaller diameter, if required.

4. Arrangement according to claim 1, characterized in that a laser source (1) is used, from which a largely coherent, parallel or slightly divergent laser beam is emitted.

5. Arrangement according to claim 1, characterized in that a laser source (1) is used, from which a laser beam is emitted onto a lens (3) or a mirror (31, 32, 51, 52), in which the light is focused or a divergent light beam is produced.

6. Arrangement according to claim 1, characterized in that at least one optics, such as a lens or a mirror arrangement, is used to widen the beam of rays or to create a divergent or widened beam of rays and after the mask there is used an additional lens or a mirror arrangement to focus the light or to create a convergent beam of rays.

7. Arrangement according to claim 1, characterized in that a diaphragm or a so-called shutter is used as the mask.

8. Arrangement according to claim 1, characterized in that lenses made of frequency-doubling material are used, so that the final resolution can be less than ¼ of the original wavelength, which means, for example, that a 100 nm structure is exposed from an original 200 nm structure.

9. Arrangement according to claim 1, characterized in that a mirror optics is arranged in front of the lens arrangement to produce a fractional beam, using a coherent laser beam.

10. Arrangement according to claim 9, characterized in that the mirror optics has a so-called beam splitter (19), suitable for dividing the laser beam, whose one of the partial beams is conveyed such that when recombined with the other laser part it is delayed, the two partial laser beams being superimposed by means of a beam splicer or mixer (20), and then the fractional beam thus produced is taken to the lens arrangement or mirror optics when using a coherent laser beam.

11. Arrangement according to claim 1, characterized in that the substrate is a base circuit board or a wafer substrate.

12. Arrangement according to claim 1, characterized in that the substrate or wafer being exposed is arranged in the parallel or convergent beam (60) so that it can be shifted in the lengthwise direction of the beam, preferably perpendicular to or possibly at a slant to the lengthwise axis of the beam.

13. Method for the exposing or production of a substrate of a wafer or chip or a micro-integrated circuit, characterized in that a laser beam, such as a coherent laser beam, is first widened and collimated as a parallel bundle of rays with a larger diameter [and¹] emitted through a mask, in which mask is arranged the circuit structure being transferred, and then the parallel, widened bundle of rays is narrowed and focused into a beam of small diameter and the structure taken up is miniaturized so as to transfer the miniaturized structure to a circuit base material or wafer substrate.
¹ Word added by translator.

14. Method according to claim 13, characterized in that the laser beam is first widened by means of a lens or a mirror arrangement, possibly collimated by means of a collimator lens into a parallel bundle of rays so that it goes as a widened parallel bundle of rays through the mask, taking up the structure arranged on the mask, then the widened parallel bundle of rays is transformed by means of a lens or a mirror arrangement into a convergent bundle of rays or a bundle of rays with a smaller diameter, and possibly again collimated by means of a collimator lens into a parallel bundle of rays, so as to transfer the thus reduced structure of the mask to the substrate, such as the chip material or wafer material.

15. Method according to claim 13, characterized in that the bundle of laser rays such as the UV laser beam is initially divided by means of a so-called beam splitter, for example, precisely 50%-50%, then one of the partial laser beams is delayed and then the two partial laser beams are recombined by means of a so-called beam splicer, to be used afterwards as a phase-shifted fractional beam in the visible or invisible region for the transferring of the circuit structure to the conductive base material.

16. Method according to claim 15, characterized in that the delay and superpositioning is, for example, 1:64, so that with a normal optics one can achieve a line resolution of (256 nm÷64)=4 nm.

17. Method according to claim 13, characterized in that the method is carried out under reduced pressure, such as preferably in a vacuum.

18. Use of the optical arrangement according to claim 1 for the production of miniature circuit boards, such as those of so-called chips, wafers, or miniaturized ICs, in particular.

19. Application of the method according to claim 15 for data recording, characterized in that the laser beam is transformed by means of the phase shift technique into a fractional beam of coherence pattern type and then used for data processing, using for example a focusing electromechanical system.
